(19) United States
(12) Patent Application Publication
(10) Pub. No.: US 2008/0158724 A1
(43) Pub. Date: Jul. 3, 2008

(54) Slider air bearing for mobile drives

(76) Inventors: Lee K. Dorius, San Jose, CA (US); Hidekazu Kohira, Kanagawa-ken (JP); Jianhua Li, Kanagawa (JP); Satoru Ookubo, Kanagawa (JP)

Correspondence Address: HITACHI C/O WAGNER BLECHER LLP, 123 WESTRIDGE DRIVE, WATSONVILLE, CA, 95076, US

(21) Appl. No.: 11/647,966

(22) Filed: Dec. 28, 2006

(51) Int. Cl. G11B 5/52; G11B 5/60

(52) U.S. Cl. 360/86; 360/235.4

(57) ABSTRACT

A head slider for a magnetic disk drive is provided. The head slider includes a leading edge, a trailing edge, an inner diameter side and an outer diameter side of an air bearing surface. The head slider further includes a first recess on the air bearing surface of the head slider, a second recess on the air bearing surface of the head slider wherein the second recess is deeper than the first recess and a third recess on the air bearing surface of the head slider wherein the third recess is deeper than the second recess and is disposed within the second recess, forming a first pocket.

### TECHNICAL FIELD

The field of the present invention relates to disk drive data storage devices. More particularly, embodiments of the present invention are related to altitude sensitivity and reduced drive speed sensitivity of a disk drive.

### BACKGROUND ART

Disk drives used in small electronic devices such as laptops, MP3 players, GPS, PDA devices and other devices are “mobile drives.” Slider air bearing is a key component of these “mobile drives.” Some of the requirements of these “mobile drives” include “low altitude sensitivity” and “high operational shock” performances.

The low altitude sensitivity means that the slider air bearing has a small fly height (FH) loss at a higher altitude (such as 3000 meters) compared to the FH at sea level. The requirement for a small FH loss becomes more important for current drives with sub 10 nanometer FH. The high operational shock requirement means that the slider air bearing would not collapse and the slider/disk interface damage would not occur during operating state when the drive experiences a very high acceleration such as impact, free drop, etc. The highest acceleration value without the interface damage is called the “op-shock” boundary. Current specification for the op-shock boundary is approximately 200 G and 2 ms duration, however, the specification is getting higher, such as 400 G/2 ms.

To reduce FH loss, a low base recess (low depth etch) or a dimple forward slider is used. However, a low base recess reduces op-shock performance and the dimple forward design degrades the op-shock also. A deeper base recess increases op-shock performance, however, the FH loss suffers drastically. The requirements of high op-shock and low FH loss are at conflict. Conventionally, FH loss has been minimized at the expense of high op-shock degradation.

### SUMMARY OF THE INVENTION

Embodiments of the present invention include a head slider for a magnetic disk drive. In one embodiment of the invention, the head slider includes a leading edge, a trailing edge, an inner diameter side and an outer diameter side of an air bearing surface. The head slider further includes a first recess on the air bearing surface of the head slider, a second recess on the air bearing surface of the head slider wherein the second recess is deeper than the first recess and a third recess on the air bearing surface of the head slider wherein the third recess is deeper than the second recess and is disposed within the second recess, forming a first pocket.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a schematic, top plan view of a hard disk drive in accordance with one embodiment of the present invention.

FIG. 2 is a top view of an exemplary disk drive slider in accordance with embodiments of the present invention.

FIG. 3 is a cross sectional view of an exemplary disk drive slider in accordance with embodiments of the present invention.

FIG. 4 is a top view of an exemplary disk drive slider comprising a plurality of pockets in accordance with embodiments of the present invention.

### DETAILED DESCRIPTION

Reference will now be made in detail to the alternative embodiment(s) of the present invention, a slider air bearing for hard disk drives. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

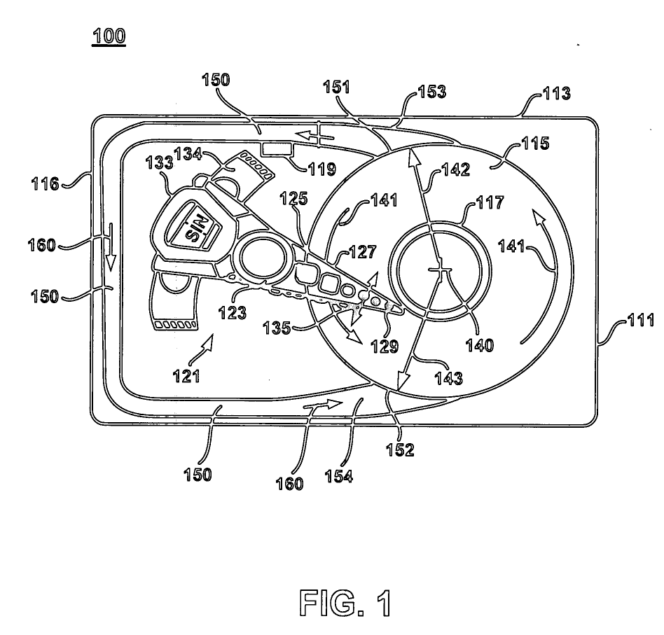

With reference now to FIG. 1, a schematic drawing of one embodiment of an information storage system 100 comprising a magnetic hard disk file or drive 111 for a computer system is shown. Drive 111 has an outer housing or base 113 containing a disk pack having at least one media or magnetic disk 115. The disk or disks 115 are rotated (see arrows 141) by a spindle motor assembly having a central drive hub 117. An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered load beam and suspension 127. A magnetic read/write transducer or head is mounted on a slider 129 and secured to a flexure that is flexibly mounted to each suspension 127. The read/write heads magnetically read data from and/or magnetically write data to disk 115. The level of integration called the head gimbal assembly (HGA) is head and the slider 129, which are mounted on suspension 127. The slider 129 is usually bonded to the end of suspension 127. The head is typically pico size (approximately 1160×1000×300 microns) and formed from ceramic or intermetallic materials. The head also may be of “femto” size (approximately 850×700×230 microns) and is pre-loaded against the surface of disk 115 (in the range two to ten grams) by suspension 127.

Suspensions 127 have a spring-like quality, which biases or urges the air-bearing surface of the slider 129 against the disk 115 to cause the slider 129 to fly at a precise distance from the disk. A voice coil 133 free to move within a conventional voice coil motor magnet assembly 134 (top pole not shown) is also mounted to arms 125 opposite the head gimbal assemblies. Movement of the actuator 121 (indicated by arrow 135) by controller 119 moves the head gimbal assemblies along radial arcs across tracks on the disk 115 until the heads settle on their respective target tracks. The head gimbal assemblies operate in a conventional manner and always move in unison with one another, unless drive 111 uses multiple independent actuators (not shown) wherein the arms can move independently of one another.

Referring still to FIG. 1, the disk pack and disks 115 (one shown) define an axis 140 of rotation 141 and radial directions 142, 143, relative to the axis 140. The drive 111 also has a bypass channel 150 formed in the housing 113 for directing the airflow 160 generated by rotation of the disks 115 from the upstream side of the disk pack or disks (e.g., proximate to radial direction 142 in FIG. 1) 115 to the downstream side of the disk pack or disks 115 (e.g., proximate to radial direction 143 in FIG. 1).

In the embodiment shown, the bypass channel 150 is located between an outer perimeter 116 of the housing 113 and the actuator 121, such that the bypass channel 150 completely circumscribes the actuator 121. Bypass channel 150 further comprises a first opening 151 proximate to upstream side wherein air is conveyed away from the disks 115 and a second opening 152 proximate to downstream side wherein airflow 160 is directed toward the disks 115.

As shown in FIG. 1, one embodiment of the drive 111 bypass channel 150 constructed in accordance with the present invention also comprises a diffuser 153. In the embodiment shown, the diffuser 153 is located in the bypass channel 150 and is positioned adjacent to the upstream side of the disk pack or disks 115. The diffuser 153 is also offset upstream from the disks 115 in the radial direction 142, such that the diffuser 153 reduces airflow drag from the disks 115 due to disk wake in the bypass channel 150. This type of aerodynamic drag is commonly called base drag.

Alternatively, or operating in conjunction with the diffuser 153, another embodiment of the drive 111 may include a contraction 154 (e.g., a Venturi). The contraction 154 is also located in the bypass channel 150, but is adjacent to the downstream side of the disk pack or disks 115. Like the diffuser 153, the contraction 154 is typically offset downstream from the disks 115, but in a radial direction 143. Each of the diffuser 153 and the contraction 154 may be spaced apart from the outer edges of the disks 115 in radial directions 142, 143 by, for example, approximately 0.5 mm. The contraction 154 may be provided for re-accelerating bypass airflow 160 to provide efficient energy conversion for the air flow from pressure energy to kinetic energy prior to merging bypass airflow 160 with air flow 141 around the disks 115.

The use of bypass channel 150 has several advantages, including the ability to reduce aerodynamic buffeting of actuator 121 during the servo writing process and/or during normal operation of disk drive system 111. More specifically, bypass channel 150 reduces the pressure build-up on the upstream side of actuator 121 which occurs when drive 111 is operated. Additionally, directing airflow 160 around the actuator 121 decreases the upstream pressure on the actuator, thus reducing force acting on the actuator 121 while reducing the energy of the bluff-body wake of the actuator arm.

In embodiments of the present invention, disk drive system 111 may be filled with a gas (e.g., helium) rather than ambient air. This may be advantageous in that helium is a lighter gas than ambient air and causes less buffeting of actuator 121 when disk drive system 111 is in operation. In embodiments of the present invention, disk drive 111 may be sealed after the servo writing process to keep the helium in the drive. Alternatively, the helium may be removed from disk drive 111 and ambient air is allowed to return into the disk drive prior to sealing first opening 151 and second opening 152.

To improve magnetic head positioning accuracy, it is necessary to write servo information with lower rotational speed than steady state speed. Embodiments of the present invention include an air bearing surface (ABS) design which is insensitive to rotational speed and altitude simultaneously.

Embodiments of the present invention use multiple etch depths on the air bearing surface of a disk drive slider to improve fly height loss at high altitudes and/or reduced operating speeds, especially while writing servo tracks. More particularly, embodiments of the present invention include a disk drive slider with a pocket close to the leading edge of the slider. Embodiments of the present invention are directed towards disk drives for use in portable electronic devices, however, the present invention is well suited to any disk drive system.

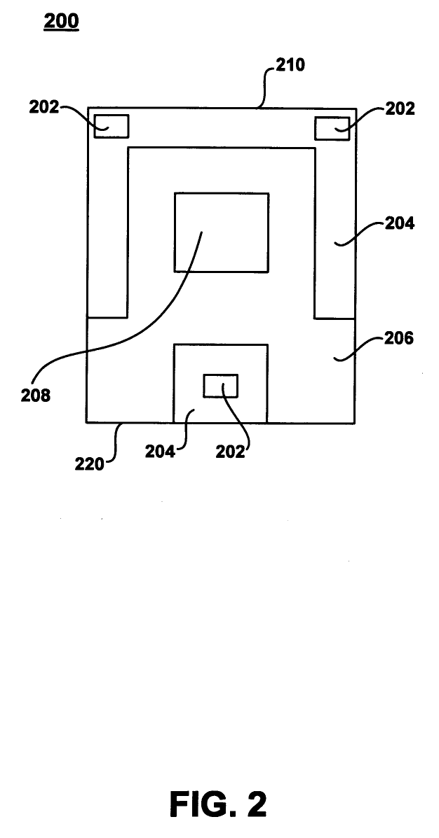

FIG. 2 is a top view of an exemplary disk drive slider 200 in accordance with embodiments of the present invention. In one embodiment of the invention, the slider 200 includes a first recess 204 formed in the slider 200. In one embodiment of the invention, the first recess forms the air bearing surfaces 202. In one embodiment of the invention, the first recess is located closer to the leading edge 210 of the slider 200 than the trailing edge 220 of the slider 200.

In one embodiment of the invention, the first recess comprises two separate recesses, one near the leading edge 210 and one near the trailing edge 220. In this embodiment of the invention, multiple portions of the first recess may be of differing sizes. However, the different portions of the first recess are of the same depth with respect to the air bearing surfaces 202.

In one embodiment of the invention, the slider 200 further includes a second recess 206. In one embodiment of the invention, the second recess 206 is deeper than the first recess 204. In one embodiment of the invention, the second recess 206 creates a negative pressure region on the air bearing side of the slider 200 when the slider is in operation.

In one embodiment of the invention, the slider 200 further includes a third recess 208. In one embodiment of the invention, the third recess 208 is deeper than the second recess 206. In one embodiment of the invention, the third recess 208 is disposed within the area defining the second recess 206. In other words, the third recess 208 defines a pocket within the region of the second recess 206. In one embodiment of the invention, the third recess 208 is located closer to the leading edge 210 than the trailing edge 220 of the slider 200.

In one embodiment of the invention, the third recess 208 is at least one micron deeper than the second recess 206. In another embodiment of the invention, the third recess is at least 2.5 microns deep with respect to the air bearing surface 202. In other embodiments of the present invention, the third recess 208 is at least twice the depth as the second recess 206.

In one embodiment of the invention, the first recess 204 is approximately 0.14 microns deep with respect to the ABS 202, the second recess 206 is approximately 0.7 microns deep with respect to the ABS 202 and the third recess 208 is approximately 2.7 microns deep with respect to the ABS 202. It is appreciated that the above mentioned depths are exemplary and are intended as an example slider configuration in accordance with embodiments of the present invention.

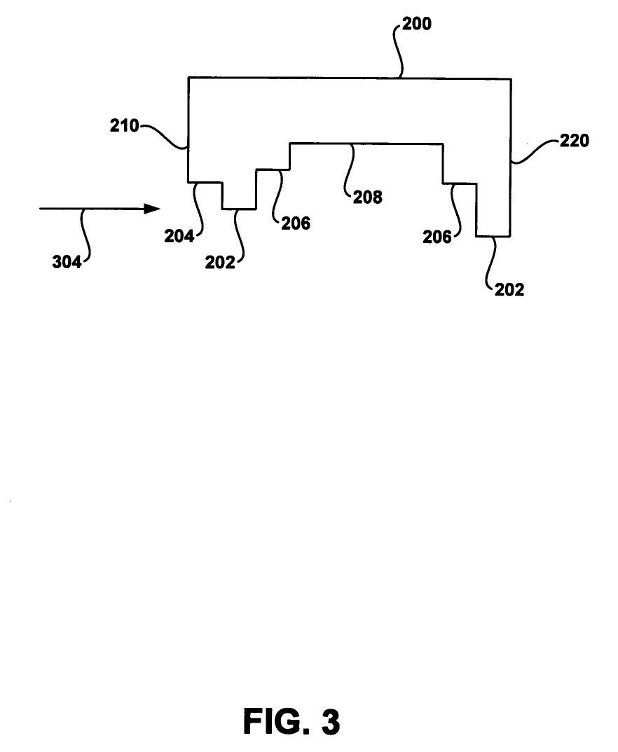

FIG. 3 is a cross sectional view of an exemplary disk drive slider 200 in accordance with embodiments of the present invention. As stated above, the third recess 208 forms a pocket that is confined within the area defining the second recess 206. The pocket controls pressure on the air bearing side of the slider 200 which makes the slider 200 simultaneously less sensitive to altitude and rotational speed. In one embodiment of the invention, the pocket is disposed closer to the leading edge 210 of the slider 200 with respect to the airflow 304 than the trailing edge 220.

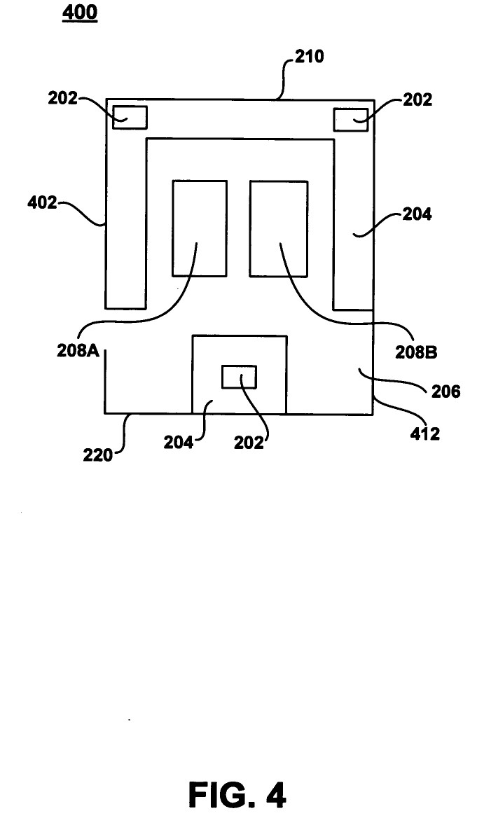

FIG. 4 is a top view of an exemplary disk drive slider 400 comprising a plurality of pockets in accordance with embodiments of the present invention. In one embodiment of the invention, more than one pocket is formed within the area defining the second recess 206. For example, pockets 208A and 208B are within the area of the second recess 206. In one embodiment of the invention, pocket 208A is larger than pocket 208B. In one embodiment of the invention, the larger pocket is located on the inner diameter side 402 of the slider 400 and the smaller pocket is located closer to the outer diameter side 412 of the slider 400. In one embodiment of the invention, the pockets 208A and 208B may be of differing depths. However, in this embodiment of the invention, both pockets are deeper than the second recess 206.

The foregoing descriptions of specific embodiments of the present invention have presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A head slider for a magnetic disk drive, said slider comprising a leading edge, a trailing edge, an inner diameter side and an outer diameter side of an air bearing surface, said head slider further comprising:
a first recess on said air bearing surface of said head slider;
a second recess on said air bearing surface of said head slider wherein said second recess is deeper than said first recess; and
a third recess on said air bearing surface of said head slider wherein said third recess is deeper than said second recess and is disposed within said second recess, forming a first pocket.

2. The head slider as described in claim 1 wherein said first pocket is closer to said leading edge than said trailing edge.

3. The head slider as described in claim 1 wherein said third recess is at least one micron deeper than said second recess.

4. The head slider as described in claim 1 wherein said third recess is at least 2.5 microns deep.

5. The head slider as described in claim 1 wherein said third recess is at least twice the depth as said second recess.

6. The head slider as described in claim 1 further comprising:
a fourth recess on said air bearing surface of said head slider wherein said fourth recess is deeper than said second recess and is disposed within said second recess, forming a second pocket.

7. The head slider as described in claim 6 wherein said first pocket is larger than said second pocket and wherein said first pocket is located closer to said inner diameter side of said head slider than said second pocket.

8. A disk drive assembly comprising:
a rotatable magnetic disk; and
a head gimbal assembly coupled to an actuator, said head gimbal assembly comprising a head slider, said slider comprising a leading edge, a trailing edge, an inner diameter side and an outer diameter side of an air bearing surface, said head slider further comprising:
a first recess on said air bearing surface of said head slider;
a second recess on said air bearing surface of said head slider wherein said second recess is deeper than said first recess; and
a third recess on said air bearing surface of said head slider wherein said third recess is deeper than said second recess and is disposed within said second recess, forming a first pocket.

9. The disk drive assembly as described in claim 8 wherein said pocket is closer to said leading edge than said trailing edge.

10. The disk drive assembly as described in claim 8 wherein said third recess is at least one micron deeper than said second recess.

11. The disk drive assembly as described in claim 8 wherein said third recess is at least 2.7 microns deep.

12. The disk drive assembly as described in claim 8 wherein said third recess is at least twice the depth as said second recess.

13. The disk drive assembly as described in claim 8 wherein said head slider further comprises:
a fourth recess on said air bearing surface of said head slider wherein said fourth recess is deeper than said second recess and is disposed within said second recess, forming a second pocket.

14. The disk drive assembly as described in claim 13 wherein said first pocket is larger than said second pocket and wherein said first pocket is located closer to said inner diameter side of said head slider than said second pocket.

15. A head gimbal assembly comprising a head slider for reducing fly height loss at altitude and for reducing fly height loss at lowered disk drive speeds, said head slider comprising:
an air bearing surface comprising a leading edge, a trailing edge an inner diameter side and an outer diameter side;
a first recess on said air bearing surface of said head slider;
a second recess on said air bearing surface of said head slider wherein said second recess is deeper than said first recess; and
a third recess on said air bearing surface of said head slider wherein said third recess is deeper than said second recess and is disposed within said second recess, forming a first pocket.

16. The head gimbal assembly as described in claim 15 wherein said first pocket is closer to said leading edge than said trailing edge.

17. The head gimbal assembly as described in claim 15 wherein said third recess is at least two microns deeper than said second recess.

18. The head gimbal assembly as described in claim 15 wherein said third recess is at least 3 microns deep.

19. The head gimbal assembly as described in claim 15 wherein said third recess is at least three times the depth as said second recess.

20. The head gimbal assembly as described in claim 15 further comprising:
a fourth recess on said air bearing surface of said head slider wherein said fourth recess is deeper than said second recess and is disposed within said second recess, forming a second pocket.

21. The head gimbal assembly as described in claim 20 wherein said first pocket is larger than said second pocket and wherein said first pocket is located closer to said inner diameter side of said head slider than said second pocket.
